(19) United States
(12) Patent Application Publication
(10) Pub. No.: US 2024/0284489 A1
(43) Pub. Date: Aug. 22, 2024

(54) METHOD, DEVICE AND COMPUTER READABLE MEDIUM FOR COMMUNICATIONS

(71) Applicant: NEC CORPORATION, Tokyo (JP)

(72) Inventors: Gang WANG, Beijing (CN); Lin LIANG, Beijing (CN); Zhaobang MIAO, Beijing (CN)

(73) Assignee: NEC CORPORATION, Tokyo (JP)

(21) Appl. No.: 18/291,085

(22) PCT Filed: Jul. 23, 2021
(86) PCT No.: PCT/CN2021/108271

§ 371 Date: Jan. 22, 2024

(51) Int. Cl. H04W 72/40; H04W 72/0446; H04W 72/25

(52) U.S. Cl. CPC H04W 72/40; H04W 72/0446; H04W 72/25

(57) ABSTRACT

Embodiments of the present disclosure relate to methods, devices and computer readable media for communications. A method comprises determining, at a first terminal device, at least one set of start points in time domain for sidelink transmission. Each of the at least one set comprises one or more start points. The method also comprises transmitting the sidelink transmission on at least one resource starting from one start point in the at least one set.

### TECHNICAL FIELD

Embodiments of the present disclosure generally relate to the field of telecommunication, and in particular, to methods, devices and computer readable media for sidelink communication.

### BACKGROUND

Sidelink in unlicensed spectrum or band (SL-U) is a key topic in Release 18 of the 3rd Generation Partnership Project (3GPP).

SL-U should base on New Radio (NR) sidelink and NR-U. In NR sidelink transmission in licensed spectrum, time domain resources for the sidelink transmission are fixed by configuration or pre-configuration. In other words, the time domain resources for sidelink transmission are within a sidelink resource pool, and a certain symbol in each slot may be used as a start symbol for sidelink transmission.

For SL-U, a terminal device may receive potential sidelink transmissions as many as possible. Thus, complexity for blind detecting of the potential sidelink transmissions will be high.

### SUMMARY

In general, example embodiments of the present disclosure provide methods, devices and computer readable media for communications.

In a first aspect, there is provided a method for communications. The method comprises determining, at a first terminal device, at least one set of start points in time domain for sidelink transmission. Each of the at least one set comprises one or more start points. The method also comprises transmitting the sidelink transmission on at least one resource starting from one start point in the at least one set.

In a second aspect, there is provided a method for communications. The method comprises determining, at a second terminal device, at least one set of start points in time domain for sidelink transmission. Each of the at least one set comprises one or more start points. The method also comprises receiving the sidelink transmission on at least one resource starting from one start point in the at least one set.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a terminal device. The terminal device comprises a processor and a memory storing instructions. The memory and the instructions are configured, with the processor, to cause the terminal device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example signaling chart showing an example process for sidelink transmission in accordance with some embodiments of the present disclosure:

FIGS. 3A, 3B, 3C, 3D and 3E illustrate an example of start points in accordance with some embodiments of the present disclosure, respectively:

FIGS. 4A, 4B and 4C illustrate an example of start points in accordance with some other embodiments of the present disclosure, respectively:

FIGS. 5A and 5B illustrate an example of start points in accordance with some other embodiments of the present disclosure, respectively:

FIGS. 6A, 6B and 6C illustrate an example of start points in accordance with some other embodiments of the present disclosure, respectively:

FIGS. 7A and 7B illustrate an example of start points in accordance with some other embodiments of the present disclosure, respectively:

FIGS. 8A and 8B illustrate an example of start points in accordance with still other embodiments of the present disclosure, respectively:

FIGS. 9A, 9B and 9C illustrate an example of start points in accordance with still other embodiments of the present disclosure, respectively:

FIGS. 10A, 10B, 10C, 10D and 10E illustrate an example of start points in accordance with still other embodiments of the present disclosure, respectively:

FIG. 11 illustrates a flowchart of an example method in accordance with some embodiments of the present disclosure:

FIG. 12 illustrates a flowchart of an example method in accordance with some other embodiments of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, in NR sidelink transmission in licensed spectrum, time domain resources for the sidelink transmission are fixed by configuration or pre-configuration. In other words, the time domain resources for sidelink transmission are within a sidelink resource pool, and a certain symbol in each slot may be used as a start symbol for sidelink transmission.

Embodiments of the present disclosure provide a solution for sidelink transmission so as to solve the above problems and one or more of other potential problems. According to the solution, a first terminal device determines at least one set of start points in time domain for sidelink transmission. Each of the set comprises one or more start points. The first terminal device performs the sidelink transmission on at least one resource starting from one of the start points. This solution may facilitate blind decoding of sidelink signal in unlicensed band.

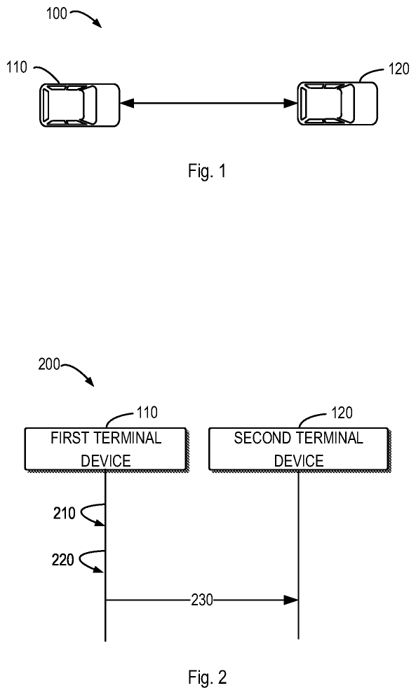

FIG. 1 illustrates a schematic diagram of an example communication network 100 in which embodiments of the present disclosure can be implemented. As shown in FIG. 1, the communication network 100 may include a first terminal device 110 and a second terminal device 120. It should be understood that the communication network 100 may further include a network device (not shown). The network device may communicate with the first terminal device 110 and the second terminal device 120 via respective wireless communication channels. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

In FIG. 1, the first terminal device 110 and the second terminal device 120 are shown as vehicles which enable V2X communications. It is to be understood that embodiments of the present disclosure are also applicable to other terminal devices than vehicles, such as mobile phones, sensors and so on.

The first terminal device 110 determines at least one set of start points in time domain for sidelink transmission. Each of the set comprises one or more start points. In some embodiments, the first terminal device 110 may perform an LBT process. If the LBT process succeeds, the first terminal device 110 performs the sidelink transmission to the second terminal device 120 on at least one resource starting from the one start point in the at least one set.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

FIG. 2 illustrates an example signaling chart showing an example process 200 for resource selection in accordance with some embodiments of the present disclosure. As shown in FIG. 2, the process 200 may involve the first terminal device 110 and the second terminal device 120 as shown in FIG. 1. It is to be understood that the process 200 may include additional acts not shown and/or may omit some acts as shown, and the scope of the present disclosure is not limited in this regard. In addition, it will be appreciated that, although primarily presented herein as being performed serially, at least a portion of the acts of the process 200 may be performed contemporaneously or in a different order than that presented in FIG. 2.

As shown in FIG. 2, the first terminal device 110 determines (210) at least one set of start points in time domain for sidelink transmission. Each of the set comprises one or more start points.

The first terminal device 110 transmits (230) the sidelink transmission to the second terminal device 120 on at least one resource starting from one start point in the set. Accordingly, the second terminal device 120 receives the sidelink transmission from the first terminal device 110 on at least one resource starting from one start point in the at least one set.

In some embodiments, optionally, the first terminal device 110 may perform (220) a LBT process before one start point. If the LBT process succeeds, the first terminal device 110 transmits the sidelink transmission on at least one resource starting from one start point in the set.

In some embodiments, the start points of one set are presented with a period. The period of the start points in one set may be determined based on a number of resource units in time domain. Each of the resource units may be an NR Uu physical resource unit, including slot, half-slot, mini-slot, symbol. Thus, the scheme of SL-U may be aligned with legacy sidelink transmission scheme.

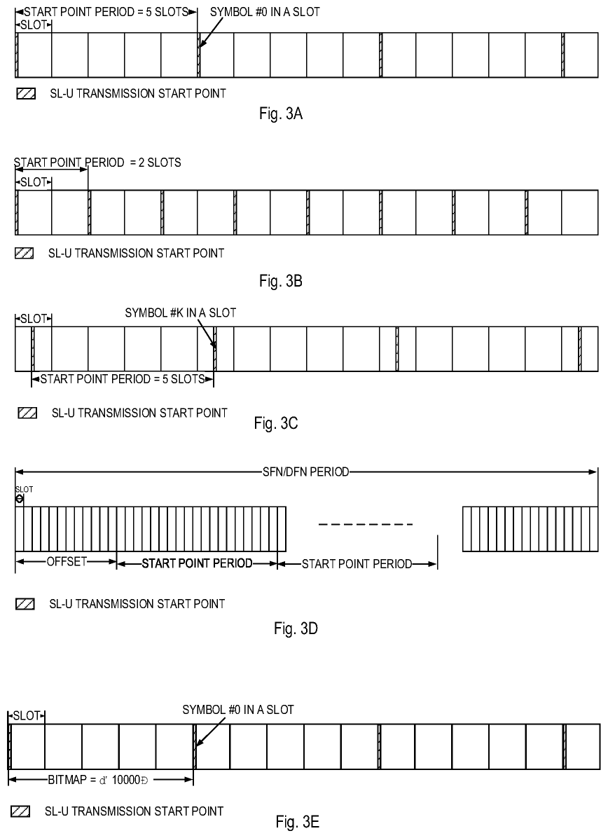

In some embodiments, each of the resource units in time domain may be a slot. This will be described with reference to FIGS. 3A, 3B and 3C. FIGS. 3A, 3B and 3C illustrate an example of start points in accordance with some embodiments of the present disclosure, respectively.

In the examples as shown in FIGS. 3A, 3B and 3C, a period of start points (which is also referred to as a start point period) is determined based on the number of slots. In other words, the period of start points in a set is counted based on the number of slots. The start point of SL-U transmission is located on a symbol. That is, the terminal device may start sidelink transmission on the dedicated symbols.

As shown in FIG. 3A, the start point period is five slots and a start symbol (i.e., symbol #0) in a slot is used as a start point.

As shown in FIG. 3B, the start point period is two slots and a start symbol (i.e., symbol #0) in a slot is used as a start point.

As shown in FIG. 3C, the start point period is five slots and a symbol other than the start symbol in a slot is used as a start point. For example, symbol #k in a slot may be used as a start point, where k is a positive integer.

In some embodiments, a boundary of the start point period may be determined based on at least one of the following: system frame number, direct frame number, an offset to boundary of the system frame number, an offset to boundary of the direct frame number. This will be described with reference to FIG. 3D.

FIG. 3D illustrates an example of a period of start points in accordance with some embodiments of the present disclosure. In the examples as shown in FIG. 3D, a boundary of the start point period is determined based on an offset to boundary of the system frame number or an offset to boundary of the direct frame number.

In some embodiments, the period and the location of the start points may be determined according to a bitmap indication which may be indicated by a network devices, or sidelink device. According to the bitmap indication, one bit of the bitmap related to one slot, and the bit set to “1” means the responding slot contains the start point(s). This will be described with reference to FIG. 3E.

FIG. 3E illustrates an example of a configuration of the start points in accordance with some embodiments of the present disclosure. In the examples as shown in FIG. 3E, a bitmap indication “10000” is assigned by gNB. According to the indication, the slots in accordance with the bit set to “1” are the slot contain the start points. Within the indicated slots, at least one symbol is used as the start point, i.e., symbol #0 in the FIG. 3E. The bitmap indication can repeat mapping, i.e. the length of the bitmap is the period of start points.

In some embodiments, each of the resource units in time domain may be a half-slot, mini-slot, or symbol. In other words, the start point period is defined as a certain number of half-slot, mini-slot, or symbols.

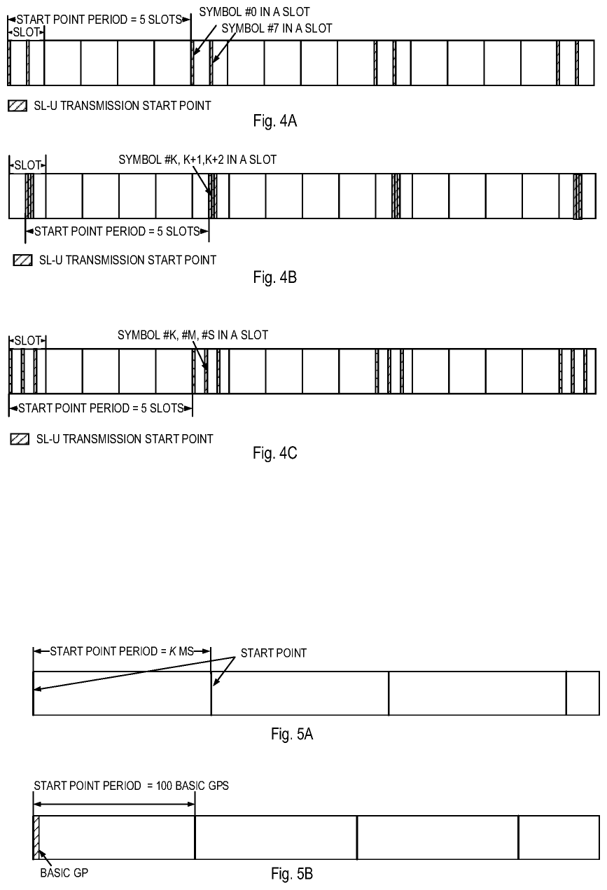

In some embodiments, one set of start points may comprise a plurality of symbols in a single slot. In other words, a plurality of symbols in one slot may be used as start points. This will be described with reference to FIGS. 4A, 4B and 4C. FIGS. 4A, 4B and 4C illustrate an example of start points in accordance with still other embodiments of the present disclosure, respectively.

In the example as shown in FIG. 4A, the start point period is five slots and symbols #0 and #7 in a slot are used as start points.

As shown in FIG. 4B, the start point period is five slots and three consecutive symbols in a slot are used as start points. For example, symbols #k, k+1 and k+2 in a slot are used as start points, where k is an integer.

As shown in FIG. 4C, the start point period is five slots and three non-consecutive symbols in a slot are used as start points. For example, symbols #k, m and s in a slot are used as start points, where k, m and s are integers, and k<m<s.

In some embodiments, considering the characteristic of sidelink transmission in unlicensed band, the period of the start point of SL-U transmission may be determined according to the LBT related resource unit in time domain, including sensing slot, transmission guard period. In other words, a period of each set of the start points may be determined based on a timing interval or a number of basic period. Hereinafter, the basic period may be also referred to as a basic guard period (GP) or GP. A length of the timing interval or the basic period may be fixed, pre-configured or predefined. In this way, the scheme of SL-U transmission may be aligned with transmission scheme of unlicensed band and LBT process. Using the typical time length as the basic period for the period of start point of SL-U may provide more opportunities for SL-U resource occupation.

In some embodiments, the timing interval or the basic period may be associated with at least one of the following: a number of milliseconds (ms), or a number of microseconds (us). Examples of the number of us may include but are not limited to 5 us, 9 us, 16 us or 25 us. This will be described with reference to FIGS. 5A and 5B.

FIGS. 5A and 5B illustrate an example of the period of start points in accordance with still other embodiments of the present disclosure, respectively. In the example as shown in FIG. 5A, the start point period is k ms, where k is a positive integer, defined in sidelink communication system. In the example as shown in FIG. 5B, the start point period is 100 basic GPs, where in the basic GP is 16 us.

In some embodiments, the at least one set of start points may be determined based on at least one of the following: a flag signal, or a flag channel. In other words, setting the start points according to a dedicated signal or channel, i.e., using the signal as a flag to further determine the potential start point of SL-U transmission. In some embodiments, a boundary of the start point period may be determined based on the flag signal, or the flag channel. In this way, more flexible opportunity of start points for sidelink transmission may be provided.

In some embodiments, the flag signal may comprise at least one of the following: sidelink system synchronization block (SL-SSB) transmitted by a sidelink terminal device, or system synchronization block (SSB) transmitted by a network device.

In some embodiments, the flag signal may comprise preamble signal transmitted by a sidelink terminal device, Road Side Unit (RSU), relay node, or a header terminal device in a group.

In some embodiments, the flag signal may comprise sidelink discovery signal, signal of sidelink control information (SCI) or feedback which is transmitted by a sidelink terminal device, RSU, relay node, or a header terminal device in a group, or signal of downlink control information (DCI) which is transmitted by a network device

In some embodiments, the flag channel may comprise at least one of the following: Physical Sidelink Discovery Channel (PSDCH), Physical Sidelink Shared channel (PSSCH), Physical Sidelink Feedback Channel (PSFCH), Physical Sidelink Broadcast Channel (PSSCH), or Physical Downlink Control Channel (PDCCH).

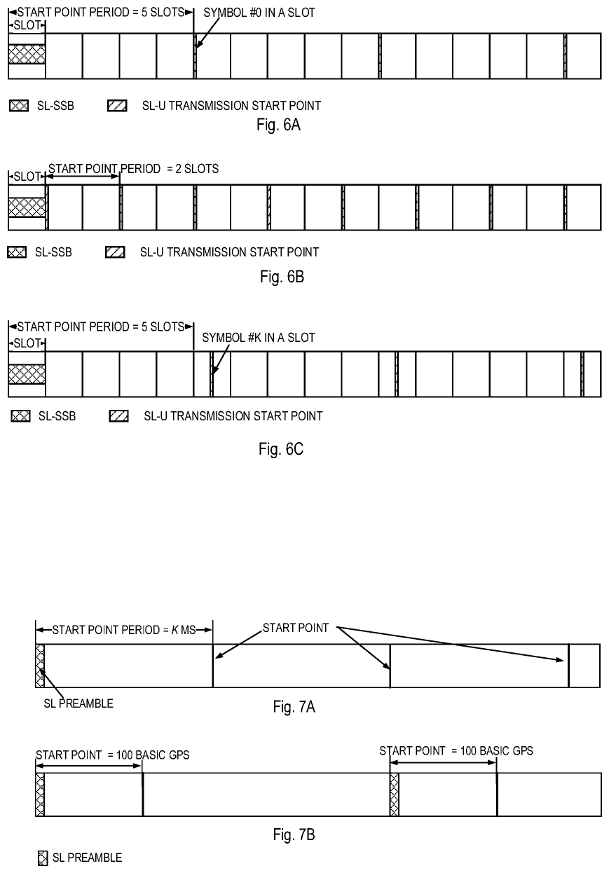

FIGS. 6A, 6B and 6C illustrate an example of start points in accordance with some embodiments of the present disclosure, respectively. In the examples as shown in FIGS. 6A, 6B and 6C, a boundary of the start point period is determined based on a flag signal and a start point period is determined based on the number of slots.

As shown in FIG. 6A, the start point period is five slots and a start symbol (i.e., symbol #0) in a slot is used as a start point. SL-SSB is used as the flag signal and a boundary of the start point period is calculated from the slot of SL-SSB.

As shown in FIG. 6B, the start point period is two slots and a start symbol (i.e., symbol #0) in a slot is used as a start point. SL-SSB is used as the flag signal and a boundary of the start point period is calculated from the slot following the slot of SL-SSB.

As shown in FIG. 6C, the start point period is five slots and a symbol other than the start symbol in a slot is used as a start point. For example, symbol #k in a slot may be used as a start point, where k is a positive integer. SL-SSB is used as the flag signal and a boundary of the start point period is calculated from the slot of SL-SSB.

FIGS. 7A and 7B illustrate an example of start points in accordance with some embodiments of the present disclosure, respectively. In the example as shown in FIG. 7A, a boundary of the start point period is determined based on a flag signal and a start point period is determined based on the timing interval. As shown in FIG. 7A, the start point period is k ms, where k is a positive integer. SL-preamble is used as the flag signal and a boundary of the start point period is calculated from the slot of SL-preamble.

In the example as shown in FIG. 7B, a start point is not periodic. The start point is determined based on at least one of the following: a one-to-one mapping between the start point and a flag signal, or a one-to-one mapping between the start point and a flag channel. As shown in FIG. 7B, SL-preamble is used as the flag signal

In some embodiments, the at least one set of start points may be determined based on at least one of the following: a type of a sidelink signal, or a type of sidelink channel. In other words, start points of SL-U may be defined or (pre-)configured for different types of signals or channels independently. With dedicated definition or (pre-)configuration of start points, more important signal or data, or high priority signal or data would have more opportunities to occupy resources.

In some embodiments, the type of the sidelink signal may comprise at least one of the following: signal of sidelink control information (SCI), sidelink data, positive acknowledge (ACK) or negative acknowledge (NACK) of sidelink transmission, sidelink CSI (Channel-state information), SL-SSB, or sidelink discovery signal.

In some embodiments, the type of the sidelink channel may comprise at least one of the following: physical sidelink control channel (PSCCH), physical sidelink shared channel (PSSCH), physical sidelink feedback channel (PSFCH), physical sidelink broadcast channel (PSBCH), or physical sidelink discovery channel (PSDCH).

In some embodiments, the type of the sidelink transmission may comprise at least one of the following: sidelink unicast transmission, sidelink groupcast transmission, or sidelink broadcast transmission.

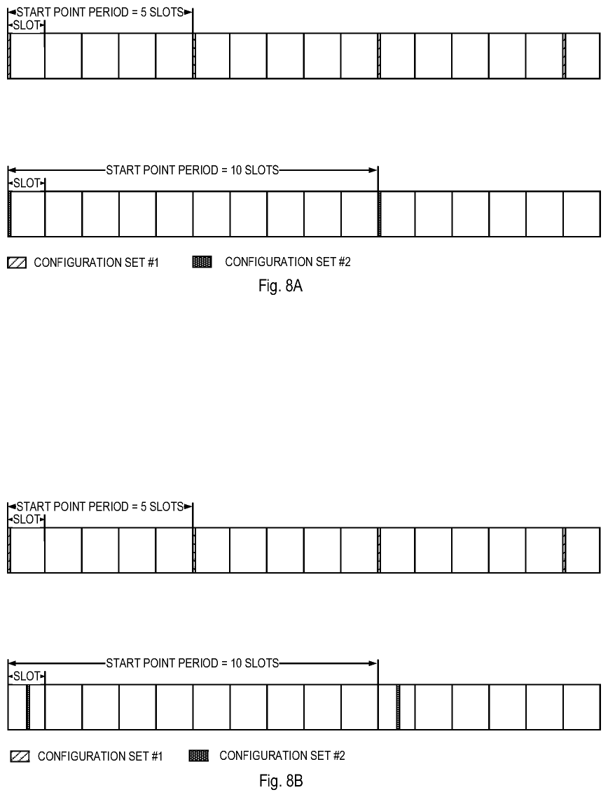

FIGS. 8A and 8B illustrate an example of start points in accordance with some embodiments of the present disclosure, respectively. In the examples as shown in FIGS. 8A and 8B, two sets of start points are determined based on the type of the sidelink signal, or the type of the sidelink channel.

As shown in FIGS. 8A and 8B, a first set of start points (which is also referred to as configuration set #1) is configured for sidelink control information related signal or channel, including PSCCH, PSFCH, PSBCH, SL-SSB, SCI. A second set of start points (which is also referred to as configuration set #2) is configured for PSSCH, sidelink data, PSDCH. In the example as shown in FIG. 8A, the start points in the first set is partially overlapped with the second set. In the example as shown in FIG. 8B, the start points in the first and second sets are non-overlapped.

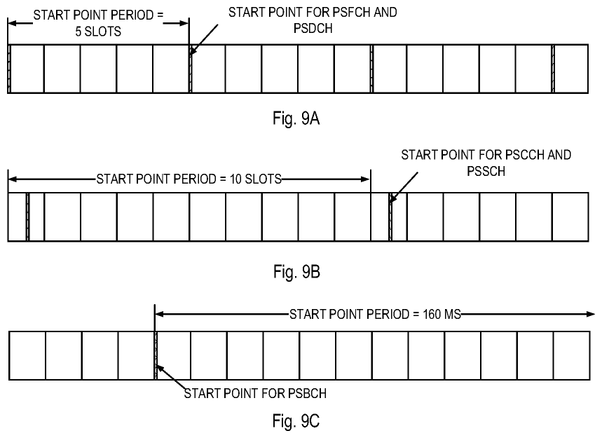

FIGS. 9A, 9B and 9C illustrate an example of start points in accordance with some embodiments of the present disclosure, respectively. In the examples as shown in FIGS. 9A, 9B and 9C, dedicated sets of start points are determined based on the type of sidelink channels.

As shown in FIG. 9A, a first set of start points is configured for PSFCH and PSDCH with start point period is 5 slots and symbol #0 in a slot is used as a start point. As shown in FIG. 9B, a second set of start points is configured for PSCCH and PSSCH with start point period is 10 slots and symbol #k in a slot is used as a start point. As shown in FIG. 9C, a third set of start points is configured for PSBCH with start point period is 160 slots and symbol #0 in a slot is used as a start point. It may be noted that a boundary of a period for the first set of start points is the same as that of a period for the second set of start points, while a boundary of a period for the third set of start points is different from those of the periods for the first and second sets of start points.

In some embodiments, the at least one set of start points may be determined based on a priority class associated with a sidelink signal, a priority class associated with a sidelink channel, a priority class of a sidelink transmission, or a priority class of a sidelink data packet. Because the priority class is introduced to identify the relationship between sidelink signal, sidelink channel or sidelink transmission and the set of start points, the configuration overhead and complexity may be reduced.

Table 1 shows an example of priority class definition of signals or channels which should be pre-defined in system.

TABLE 1

| Priority class | Signal or channel |
|---|---|
| 1 | SL-SS, PSBCH, PSDCH, preamble signal |
| 2 | PSCCH, PSFCH, SCI |
| 3 | PSSCH, sidelink data with priority level #0~#3 |
| 4 | PSSCH, sidelink data with priority level #4~#7 |

Table 2 shows another example of priority class definition of signals or channels which should be pre-defined in system.

TABLE 2

| Priority class | Signal or Channel |
|---|---|
| 1 | SL-SS, PSBCH, PSDCH, PSCCH, SCI, preamble signal |
| 2 | PSSCH, PSFCH, sidelink data with priority level #0~#2 |
| 3 | PSSCH, PSFCH, sidelink data with priority level #3~#5 |
| 4 | PSSCH, PSFCH, sidelink data with priority level #6~#7 |

Table 3 shows an example of priority class definition of sidelink transmission which should be pre-defined in system.

TABLE 3

| Priority class | Sidelink transmission |
|---|---|
| 1 | Sidelink broadcast |
| 2 | Sidelink groupcast |
| 3 | Sidelink unicast |
| 4 | reserved |

In some embodiments, considering the diverse requirements of sidelink transmission, it is reasonable to define corresponding set of start points according to different factors. This may provide some other ways to determine the set of start points according to other factors which may benefit sidelink transmission in unlicensed band and suitable for some specific use cases.

For example, the at least one set of start points may be determined based on a type of the sidelink transmission. The type of the sidelink transmission may comprise at least one of the following: sidelink unicast transmission, sidelink groupcast transmission, or sidelink broadcast transmission.

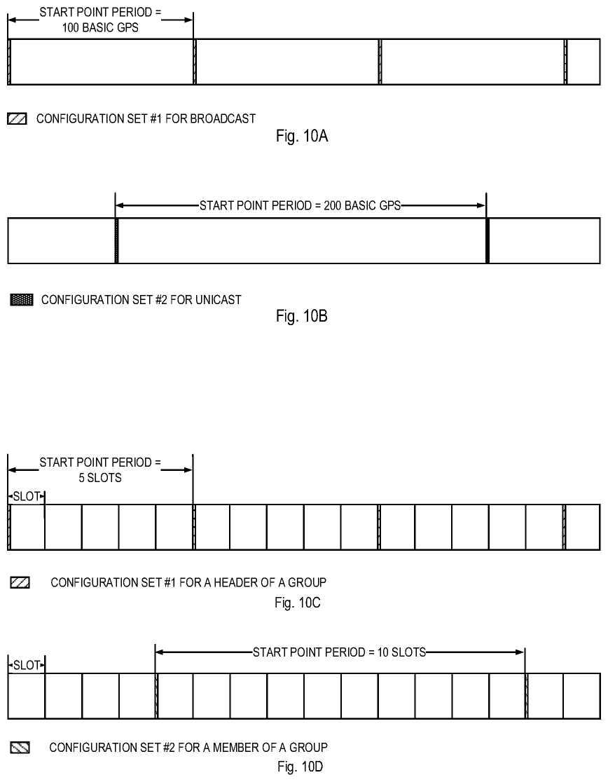

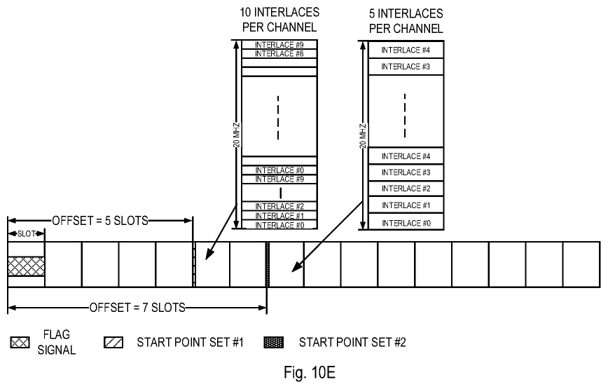

FIGS. 10A and 10B illustrate an example of start points in accordance with some embodiments of the present disclosure, respectively. In the examples as shown in FIGS. 10A and 10B, two sets of start points are determined based on a type of sidelink transmission.

As shown in FIG. 10A, a first set of start points (which is also referred to as configuration set #1) is used for sidelink broadcast transmission. As shown in FIG. 10B, a second set of start points (which is also referred to as configuration set #2) is used for sidelink unicast transmission.

In some embodiments, the at least one set of start points may be determined based on a type of a terminal device. The terminal device may comprise a road side unit (RSU), a terminal device acting as a header of a group of terminal devices, a terminal device acting as a member of the group of terminal devices, or a terminal device transmitting SL-SS.

FIGS. 10C and 10D illustrate an example of start points in accordance with some embodiments of the present disclosure, respectively. In the examples as shown in FIGS. 10C and 10D, two sets of start points are determined based on a type of a terminal device.

As shown in FIG. 10C, a first set of start points (which is also referred to as configuration set #1) is configured for a header of a sidelink communication group. As shown in FIG. 10B, a second set of start points (which is also referred to as configuration set #2) is configured for one or more members of the sidelink communication group.

In some embodiments, the at least one set of start points may be determined based on a size of a data packet for the sidelink transmission, e.g., transmission block (TB) size, a size of a sub-channel or an interlace, i.e. the number of resource blocks (RB) contained in one sub-channel or interlace.

FIG. 10E illustrates an example of start points in accordance with some embodiments of the present disclosure. As shown in FIG. 10E, a first set of start points (which is also referred to as start point set #1) is configured for a first interlace structure, i.e., the size of a interlace is 10 RBs, and a second set of start points (which is also referred to as start point set #2) is configured for a second interlace structure, i.e., the size of a interlace is 20 RBs. The second interlace structure is different from the first interlace structure. The first and second sets of start points are determined based on a flag signal. A offset between the flag signal and the first set of start points is five slots and the offset between the flage signal and the second set of start points is seven slots.

In some embodiments, the at least one set of start points may be determined based on an identification (ID) of a terminal device which is the target receiving device of the sidelink transmission. For example, the ID of the terminal device may be divided into broadcast ID, groupcast ID, or target Rx UE ID for unicast.

In some embodiments, the at least one set of start points may be determined based on a latency requirement for sidelink transmission or a data packet.

In some embodiments, the at least one set of start points may be assigned as common configuration for all sidelink terminal devices which work in the same unlicensed band. A common configuration for sidelink terminal devices may benefit SL-U transmission and receiving implementation and power consumption of terminal devices.

In some embodiments, the at least one set of start points may be preconfigured. Thus, there is no explicit signaling overhead.

Alternatively, the at least one set of start points may be configured by a centralized management node. For example, the at least one set of start points may be configured through system information block (SIB) indicated by a network device. The network device may use SIB message to indicate one or more sets of start points, which indicate the configurations for each priority class descripted with reference to Table 1.

Alternatively, the at least one set of start points may be configured through a radio resource control (RRC) signaling indicated by a network device in Uu link. Alternatively, the at least one set of start points may be configured through PC5 RRC signaling indicated by RSU, sidelink relay node, a header of a group of terminal devices, or a manager node. For example, for sidelink groupcast communication, the header device of a sidelink communication group indicates a configuration of start points to the members of the group through PC5 RRC signaling. For another example, a sidelink relay node receives the configuration of start points of SL-U from a network device, and then forwards the configuration to other sidelink terminal devices.

In some embodiments, the at least one set of start points may be assigned to several sidelink terminal devices as group specific configuration, or to one target terminal device as terminal device specific configuration. It may be used for some dedicated sidelink scenarios and give more flexibility for SL-U transmission.

The specific configuration may be indicated by gNB, eNB, RSU, sidelink relay node, a header of a group of terminal devices, or a sidelink terminal device.

For example, for sidelink groupcast communication, a header device of a sidelink communication group may indicate a dedicated configuration of start points to member device(s) of the group through PC5 RRC signaling or SCI.

For another example, for sidelink unicast communication, a terminal device transmitting a sidelink signal may indicate its start points for the unicast signaling transmission to a terminal device receiving the sidelink signal through PC5 RRC signaling or SCI.

Alternatively, gNB or eNB may indicate a dedicated configuration of start points to a relay node through RRC signaling or DCI.

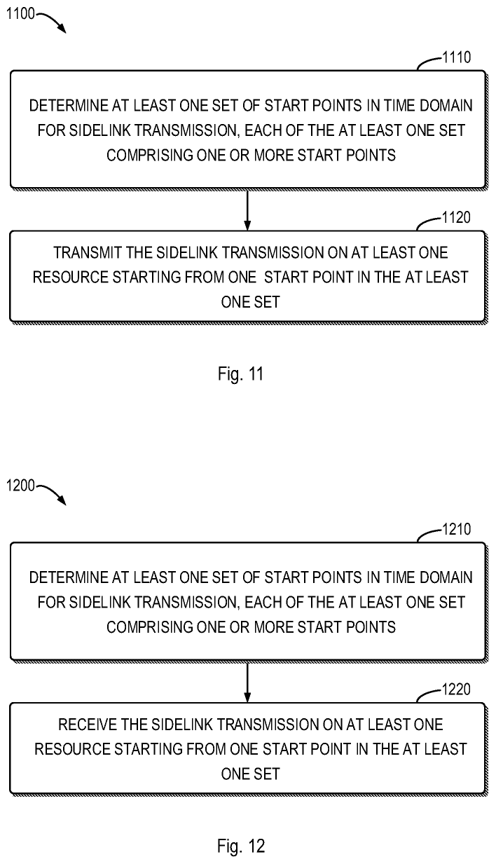

FIG. 11 illustrates a flowchart of an example method 1100 in accordance with some embodiments of the present disclosure. In some embodiments, the method 1100 can be implemented at a terminal device, such as the first terminal device 110 as shown in FIG. 1. For the purpose of discussion, the method 1100 will be described with reference to FIG. 1 as performed by the first terminal device 110 without loss of generality.

At block 1110, the first terminal device 110 determines at least one set of start points in time domain for sidelink transmission. Each of the at least one set comprises one or more start points.

At block 1120, the first terminal device 110 transmits the sidelink transmission on at least one resource starting from one start point in the at least one set.

In some embodiments, the first terminal device 110 may determine the at least one set of start points based on at least one of the following: a type of a sidelink signal, a type of a sidelink channel, a type of a sidelink transmission, a priority class of the sidelink signal, a priority class of the sidelink channel, a priority class of the sidelink transmission, a size of a data packet, a priority class of the data packet, a size of a sub-channel, a size of a interlace, an identification of a second terminal device receiving the sidelink transmission, a type of the first terminal device, a bitmap indication, or a latency requirement for the sidelink transmission or the data packet.

In some embodiments, the type of the sidelink signal comprises at least one of the following: sidelink control signal, sidelink data signal, positive acknowledge or negative acknowledge of sidelink transmission, sidelink Channel-state information signal, sidelink system synchronization block, or sidelink discovery signal.

In some embodiments, the type of the sidelink channel comprises at least one of the following: physical sidelink control channel, physical sidelink shared channel, physical sidelink feedback channel, physical sidelink broadcast channel, or physical sidelink discovery channel.

In some embodiments, the type of the sidelink transmission comprises at least one of the following: sidelink unicast transmission, sidelink groupcast transmission, or sidelink broadcast transmission.

In some embodiments, the first terminal device 110 may determine a period of the start points in one set based on at least one of the following: a number of resource units in time domain, or a timing interval.

In some embodiments, each of the resource units in time domain comprises at least one of the following: slot, half-slot, mini-slot, symbol, or basic period.

In some embodiments, the timing interval or the basic period is associated with at least one of the following: a number of milliseconds, or a number of microseconds.

In some embodiments, a boundary of the period is determined based on at least one of the following: system frame number, direct frame number, an offset to boundary of the system frame number, an offset to boundary of the direct frame number, a flag signal, or a flag channel.

In some embodiments, the first terminal device 110 may determine the at least one set of start points based on at least one of the following: a flag signal, or a flag channel.

In some embodiments, the first terminal device 110 may determine a start point in the at least one set of start points based on at least one of the following: a one-to-one mapping between the start point and a flag signal, or a one-to-one mapping between the start point and a flag channel.

In some embodiments, the at least one set of start points comprises a plurality of symbols in a single slot.

In some embodiments, the plurality of symbols comprises consecutive symbols in the single slot.

In some embodiments, the plurality of symbols comprises non-consecutive symbols in the single slot.

In some embodiments, the flag signal comprises at least one of the following: sidelink system synchronization block, system synchronization block, preamble signal, sidelink discovery signal, sidelink control signal, sidelink feedback signal, or downlink control signal.

In some embodiments, the flag channel comprises at least one of the following: physical sidelink control channel, physical sidelink shared channel, physical sidelink feedback channel, physical sidelink broadcast channel, physical sidelink discovery channel, or physical downlink control channel.

In some embodiments, additionally, the first terminal device 110 may receive configuration information about the at least one set of start points from one of the following: a network device, a road side unit, a sidelink relay node, or a sidelink terminal device.

In some embodiments, the at least one set of start points may be preconfigured.

FIG. 12 illustrates a flowchart of an example method 1200 in accordance with some embodiments of the present disclosure. In some embodiments, the method 1200 can be implemented at a terminal device, such as the second terminal device 120 as shown in FIG. 1. For the purpose of discussion, the method 1200 will be described with reference to FIG. 1 as performed by the second terminal device 120 without loss of generality.

At block 1210, the second terminal device 120 determines at least one set of start points in time domain for sidelink transmission. Each of the at least one set comprises one or more start points.

At block 1220, the second terminal device 120 receives the sidelink transmission on at least one resource starting from one start point in the at least one set.

In some embodiments, the second terminal device 120 may determine the at least one set of start points based on at least one of the following: a type of a sidelink signal, a type of a sidelink channel, a type of a sidelink transmission, a priority class of the sidelink signal, a priority class of the sidelink channel, a priority class of the sidelink transmission, a size of a data packet, a priority class of the data packet, a size of a sub-channel, a size of a interlace, an identification of a second terminal device receiving the sidelink transmission, a type of the first terminal device, a bitmap indication, or a latency requirement for the sidelink transmission or the data packet.

In some embodiments, the type of the sidelink signal comprises at least one of the following: sidelink control signal, sidelink data signal, positive acknowledge or negative acknowledge of sidelink transmission, sidelink Channel-state information signal, sidelink system synchronization block, or sidelink discovery signal.

In some embodiments, the type of the sidelink channel comprises at least one of the following: physical sidelink control channel, physical sidelink shared channel, physical sidelink feedback channel, physical sidelink broadcast channel, or physical sidelink discovery channel.

In some embodiments, the type of the sidelink transmission comprises at least one of the following: sidelink unicast transmission, sidelink groupcast transmission, or sidelink broadcast transmission.

In some embodiments, the second terminal device 120 may determine a period of the start points in one set based on at least one of the following: a number of resource units in time domain, or a timing interval.

In some embodiments, each of the resource units in time domain comprises at least one of the following: slot, half-slot, mini-slot, symbol, or basic period.

In some embodiments, the timing interval or the basic period is associated with at least one of the following: a number of milliseconds, or a number of microseconds.

In some embodiments, a boundary of the period is determined based on at least one of the following: system frame number, direct frame number, an offset to boundary of the system frame number, an offset to boundary of the direct frame number, a flag signal, or a flag channel.

In some embodiments, the second terminal device 120 may determine the at least one set of start points based on at least one of the following: a flag signal, or a flag channel.

In some embodiments, the second terminal device 120 may determine a start point in the at least one set of start points based on at least one of the following: a one-to-one mapping between the start point and a flag signal, or a one-to-one mapping between the start point and a flag channel.

In some embodiments, the at least one set of start points comprises a plurality of symbols in a single slot.

In some embodiments, the plurality of symbols comprises consecutive symbols in the single slot.

In some embodiments, the plurality of symbols comprises non-consecutive symbols in the single slot.

In some embodiments, the flag signal comprises at least one of the following: sidelink system synchronization block, system synchronization block, preamble signal, sidelink discovery signal, sidelink control signal, sidelink feedback signal, or downlink control signal.

In some embodiments, the flag channel comprises at least one of the following: physical sidelink control channel, physical sidelink shared channel, physical sidelink feedback channel, physical sidelink broadcast channel, physical sidelink discovery channel, or physical downlink control channel.

In some embodiments, additionally, the second terminal device 120 may receive configuration information about the at least one set of start points from one of the following: a network device, a road side unit, a sidelink relay node, or a sidelink terminal device.

In some embodiments, the at least one set of start points may be preconfigured.

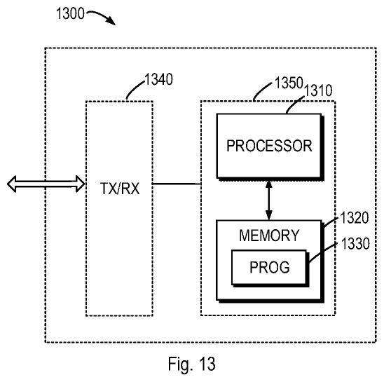

FIG. 13 is a simplified block diagram of a device 1300 that is suitable for implementing some embodiments of the present disclosure. The device 1300 can be considered as a further example embodiment of the terminal device 110 or the terminal device 120 as shown in FIG. 1. Accordingly, the device 1300 can be implemented at or as at least a part of the terminal device 110 or the terminal device 120.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1320 stores at least a part of a program 1330. The TX/RX 1340 is for bidirectional communications. The TX/RX 1340 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1330 is assumed to include program instructions that, when executed by the associated processor 1310, enable the device 1300 to operate in accordance with the embodiments of the present disclosure, as discussed herein with reference to FIGS. 2 to 12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2 to 12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-42. (canceled)

43. A method performed by a first terminal device, comprising:
receiving a configuration information indicating a first number of slots for a physical sidelink feedback channel (PSFCH) transmission; and
attempting to transmit a PSFCH over the first number of slots in response to a physical sidelink shared channel (PSSCH) reception.

44. The method of claim 43, wherein the attempting to transmit the PSFCH comprises: attempting to transmit the PSFCH in a slot within the first number of slots in response to the PSSCH reception.

45. The method of claim 43, wherein the attempting to transmit the PSFCH comprises: performing a channel access procedure before transmitting the PSFCH.

46. The method of claim 43, wherein the configuration information further indicates two start symbols for a PSSCH transmission within a slot.

47. A method performed by a second terminal device, comprising:
receiving a configuration information indicating a first number of slots for a physical sidelink feedback channel (PSFCH) reception; and
receiving a PSFCH on the first number of slots in response to a physical sidelink shared channel (PSSCH) transmission.

48. The method of claim 47, wherein the configuration information further indicates two start symbols for the PSSCH transmission within a slot.

49. A first terminal device comprising a processor configured to cause the first terminal device to:
receive a configuration information indicating a first number of slots for a physical sidelink feedback channel (PSFCH) transmission; and
attempt to transmit a PSFCH in a slot within the first number of slots in response to a physical sidelink shared channel (PSSCH) reception.

50. The first terminal device of claim 49, wherein the processor is configured to cause the first terminal device to attempt to transmit the PSFCH by attempting to transmit the PSFCH in a slot within the first number of slots in response to the PSSCH reception.

51. The first terminal device of claim 49, wherein the processor is configured to cause the first terminal device to attempt to transmit the PSFCH by performing a channel access procedure before transmitting the PSFCH.

52. The first terminal device of claim 49, wherein the configuration information further indicates two start symbols for a PSSCH transmission within a slot.

53. A second terminal device comprising a processor configured to cause the first terminal device to:
receive a configuration information indicating a first number of slots for a physical sidelink feedback channel (PSFCH) reception; and
receive a PSFCH on the first number of slots in response to a physical sidelink shared channel (PSSCH) transmission.

54. The second terminal device of claim 53, wherein the configuration information further indicates two start symbols for the PSSCH transmission within a slot.
